(19) United States
(12) Patent Application Publication
(10) Pub. No.: US 2004/0112887 A1
(43) Pub. Date: Jun. 17, 2004

(54) Method of warning individuals about hot surfaces on stoves including cooktops

(76) Inventor: William S. Lerner, New York, NY (US)

Correspondence Address: Steven Horowitz, Counselor At Low, Suite 700, 295 Madison Avenue, New York, NY, 10017, US

(21) Appl. No.: 10/658,214

(22) Filed: Sep. 8, 2003

Related U.S. Application Data
(63) Continuation-in-part of application No. 09/788,594, filed on Feb. 21, 2001, now Pat. No. 6,639,190.

(51) Int. Cl. H05B 3/68; H05B 1/02

(52) U.S. Cl. 219/445.1; 219/506

(57) ABSTRACT

A method of warning individuals about the top surface of a stove being hot involves applying to a portion said top surface surrounding each heating element of the stove a ring element of thermochromic composition that reveals a heat warning symbol to warn individuals that the heating element or near by area is too hot to touch. Liquid crystal or other thermochromic composition designed to undergo and maintain a readily perceptible color change at or above a specified temperature, such as 115 degrees Fahrenheit, is shaped in the outline of the word “HOT” or another heat warning symbol or is designed to change to a transparent color and thereby reveal underneath said composition a heat warning symbol shaped in such lettering or other warning symbol. Ring element is defined to includes a ring, an arc or a line surrounding the heating element and an arrow pointing to the heating element.

### PRIORITY INFORMATION

This patent application is a continuation-in-part patent application of (a) the presently pending U.S. patent application Ser. No. 09/788,594 (“Heat Alert Safety device for Smoothtop Stoves and other Hot Surfaces”) previously filed by Applicant and Inventor William S. Lerner on Feb. 21, 2001 and which is incorporated herein by reference in its entirety (b) the presently pending U.S. patent application Ser. No. 10/446,919 (“Heat Warning Safety Device Using Light Emitting Diodes”) previously filed by Applicant and Inventor William S. Lerner on May 28, 2003 and which is incorporated herein by reference in its entirety (c) the presently pending U.S. patent application Ser. No. 10/447,510 (“Heat Warning Devices Directly Applicable to Hot Surfaces”) previously filed by Applicant and Inventor William S. Lerner on May 28, 2003 and which is incorporated herein by reference in its entirety and (d) the presently pending U.S. patent application Ser. No. 10/612,315 (“Heating Element Accessory Having Warning Device”) previously filed by Applicant and Inventor William S. Lerner on Jul. 2, 2003 and which is incorporated herein by reference in its entirety.

### FIELD OF THE INVENTION

The present invention relates to methods of using safety devices to warn individuals about the hot surfaces that exist on a stove or other appliance, and in particular methods of using safety devices to alert someone that the surface of a smooth cooktop stove is too hot to touch.

### BACKGROUND OF THE INVENTION

With respect to stoves and related appliances, various kinds of stoves—electric, gas, smooth cooktop using glass or metal tops—and toaster ovens are well known to be used for heating food. In addition, “mobile stove-type appliances” such as hot plates and warming trays are well known to be used for heating food. Each of these kinds of stoves and “mobile stove-type appliances” present a safety problem since the heating elements of the stove are hot during the cooking process and remain hot well afterwards. During the cooking process, the safety problem caused by touching the heating element is mitigated somewhat by visual inspection of the stove. With a gas, electric or smooth top stove, for example, the presence of a pot or other utensil on top of the stove might alert someone to the fact that the stove appears to be in use for cooking and therefore too hot to touch. Even the presence of a pot or other utensil is not a reliable clue, however, since people tend to leave tea kettles on their stove perpetually. When the cooking process has ended, however, it is generally impossible to detect that the heating elements of the stove remains hot and would burn the skin of anyone who touched them. There is no visual or other clue that the stove is hot.

To some degree, adults have developed an inherent caution when approaching stoves because of their experience and knowledge in dealing with such safety problems. This inherent caution, however, does not obviate the need for a device that warns the adult when touching the stove would be dangerous. Moreover, children, and particularly young children, usually have not developed such a watchfulness and there has long been a need for a device that can prevent burn accidents to children who may inadvertently touch a stove that is hot, especially when the stove remains hot well after the cooking process has ended.

Furthermore, the reduction in the size of modern kitchens has led the occupants of modern apartments to make use of the stove as an extension of the counter top adjacent the stove as a resting places for large items that have been carried into the kitchen area. An example of such items is heavy bags of groceries brought into the kitchen. There is an urge to set the bags down on the nearest flat surfaces, which may be the top of a stove adjacent a counter top. This is particularly true for those stoves that are smooth on top, such as smooth cooktops. In general, the top surfaces of modern kitchen stoves are increasingly flat, especially the top surfaces of smooth cooktops. These factors have only increased the danger to adults when the top surfaces of stoves are used as a resting place for packages, such as groceries brought into the kitchen.

Smooth cooktop stoves presently are also dangerous if touched on their top surface when they are still hot, even after use. These smooth cooktop stoves, or “smoothtops” as they are sometimes called, utilize as the heating element separate areas on the top surface of the stove (at the same location that gas stove would have burners) which are made of glass. Under each area, usually circular, is a strong light source, such as a halogen lights. The light source projects the light upward to the surface area of the smoothtop's heating element—the glass area on the top surface of the stove. Since the glass area is coated on its bottom with a dark coating, when the light strikes it, the heat from the strong light is absorbed by the glass area and these glass surfaces form each heating element of the stove.

Another variation of the smooth cooktop is the use of a “ribbon heating element” where the smooth glass surface is heated by a coiled electric circuit called a “ribbon element” just underneath it instead of by a halogen light source. The heat is transmitted directly upward so that only the heat element itself gets hot and the rest of the cooktop surface remains cool. In some cases, the ribbon heating element also has another feature whereby the heating element is made of two concentric circles so that the option exists of two sizes of the heating element to match the two different sizes of the pans that need to be heated. This new technology does not solve the problem of warning adults and children that the heating element should not be touched when the cooking process has ended. If anything, it generates the additional hazard that someone can be lulled into touching the heating element after thinking the heating element is cool since the surface right adjacent to it is indeed cool.

With respect to toaster ovens, because of its mobility the danger of touching the window of a toaster oven exceeds that of the typical immobile oven. The toaster oven can be placed on a counter top or other portion of the kitchen not directly in the “cooking center”. Consequently, an adult and especially a child, or the elderly, is not likely to remember not to touch a window of a toaster oven when it is off (soon after it had been on). In addition, the door of a toaster oven can be left open and jut out further toward someone in the kitchen.

Presently, in order to address the danger of touching a hot “smoothtop” stove, such stoves generally have several light indicators, each one corresponding to each heating element, all located in small one rectangular area on the surface of the cooktop. The light indicators remain lit for a certain length of time after the stove's heating element is turned off in order to deter someone from touching the heating element when it is still hot, although “off”. Unfortunately, this attempt to address the danger of touching a hot stove of the smooth cooktop variety is insufficient as a warning system (putting aside the fact that the light indicators are designed only for the smooth cooktop variety stoves to begin with and not for gas and electric coil stoves).

A quick glance at the group of light indicators would not be sufficient to warn the average adult, no less children or the elderly, that a particular heating element is too hot. This is because the group of light indicators do not immediately tell someone which heating elements correspond to which light indicators. At a minimum, several seconds of concentration are needed in order to determine from the light indicators that are “on”, which heating elements are too hot to touch. Most adults, and certainly most children, cannot afford those seconds of deduction since their desire to touch the stove is immediate. In addition, an adult carrying groceries into the kitchen and looking for a counter top to place them on or a child running into and playing in the kitchen are even less likely than the average adult or child to take the time to engage in a several second thinking process. Accordingly, the child or the adult will be inadequately warned about the danger of being burned. With this in mind, it is no surprise that a 1997 industrial design exhibit at the Cooper Hewitt (Smithsonian) in New York demonstrated that over 69% of adults can not match the control knob with its corresponding burner (i.e. heating element) on a stove.

Furthermore, the prior art heat indicators can be up to three feet away from the heating element to which they correspond. That distance is too far away for a dangerously hot surface. Surely one would not position a warning for an open air shaft three feet away.

Moreover, the use of a single red LED dot to communicate a warning of heat, while it may have been somewhat noticeable and somewhat effective as a heat warning symbol in the kitchen of the past, is completely ineffective today. In today's kitchen environment, the meaning of a dot of a red LED is dramatically diluted by the presence of a multitude of dots of red LED's all over the place in the modern sophisticated kitchen. For example, many appliances in the kitchen such as coffee pots, cell phones, corded phones, answering machines, computers, televisions, rechargeable flashlights, personal digital assistant devices, dustbusters, alarm keypads, motion sensors all have red lights or red LED's. This dilutes the meaning of a single red LED as an indicator of dangerous heat on a nearby heating element.

Moreover, for yet an additional reason, the above problems with existing heat indicators are even more pronounced when considered in the context of today's modern kitchen. The traditional kitchen in the past has been the domain of a stay at home mother. The kitchen contained one corded telephone and a cooktop stove would be plainly obvious and salient in such a kitchen. Today's kitchen is much more distracting. In today's kitchen, it is more common, at least in many households, for everyone to cook. Furthermore, the kitchen itself in many cases functions also as an entertainment room, a living room or a family room. The kitchen and its inhabitants feature cordless telephones, computers announcing “you have mail”, cell phones, pagers and people milling about “multi-tasking”, talking, drinking, socializing and not just cooking. Guests may be unfamiliar with cooking areas. Smoothtop stoves are not so distinctive in this environment since they have been re-designed to blend into the kitchen design. Smoothtops are also not immediately recognizable as smoothtops because the new designs are odd in shape. Also, where previously versions had a vent hood that stuck out, such vent hoods are now often built into the cabinet and remain unseen.

Furthermore, stoves appear in islands in the middle of the kitchen separate from any oven rather than against the wall and adjacent the oven. Hence, a potentially hot surface can be approached from four different directions in a distracting environment when the danger may be hard to recognize. It is not hard to see that the prior art indicators, such as shown in FIG. 4 of U.S. Pat. No. 6,104,007 to Lerner, which appear on only one side of a cooktop stove, are practically useless in today's kitchen, even putting aside the fact that they require precious seconds of deduction to figure out which dangerously hot heating element it is supposed to correspond to the lit indicator warning light.

In addition, some people may not have grown up with smoothtops and may not recognize it. The elderly, children, visually impaired individuals would all have trouble using prior art heat warning indicators on a smoothtop to warn against the residual heat of a heating element on a smoothtop stove, or for that matter other stoves or hot surfaces.

There is also not presently known any effective warning method for the vertical surfaces of oven windows, including the windows of wall ovens, regular ovens and toaster ovens. This is particularly important since when the oven is turned off, the oven window remains very hot even though it appears that everything is off.

In addition, while devices that make use of liquid crystal compositions are known to indicate the surface temperature of an appliance, these devices are not designed to warn someone of the danger of touching hot stoves. For example, U.S. Pat. No. 3,827,301 to Parker discloses an apparatus for indicating the temperature of a surface of an appliance. It has a first portion in contact with the appliance surface or connected by copper wires or heat pipes to the appliance surface. It has a second portion, a poor heat conducting member in heat exchanging relationship to the ambient environment, that has bands of liquid crystal material extending away from the first portion thereby creating a temperature gradient extending away from the surface of the appliance.

Devices such as disclosed in Parker that provide temperature determinations are not adequate for instantly warning a child or even an adult that the heating element of a stove is too hot to touch for one thing because quantitative temperature determinations are inadequate to provide the immediate warning that is necessary. Moreover, the device of Parker and other liquid crystal compositions are not specifically suited to be manufactured as part of a stove. In addition, these devices are not suitable as attachments to stoves and certainly not as attachments to a smooth cooktop stove.

A heat alert safety device in the form of a ring of thermochromic composition embedded under a top surface of a smooth cooktop stove has the disadvantage that the device has to be looked at from a certain angle to be visible since the heat warning symbol associated with the thermochromic composition is underneath glass. Furthermore, manufacturing a cook top stove with such a device built in would require changing the way the glass and the wiring, heating element etc is manufactured. It would all have to be changed and this requires time and expense. In addition, such a heat alert safety device uses up bulk.

In addition, if the thermochromic composition is in a central area of the smooth area of glass on the top surface of the cooktop stove, it is covered by pots and as part of the heating element it gets very hot. This would require using only specialized and less available and more expensive thermochromic compositions that can withstand such a high temperature.

Accordingly, it would be valuable to have a method of warning individuals of hot surfaces on a smooth cooktop stove that does not make use of heat alert safety devices tat are blocked by pots or whose visibility is reduced by being underneath glass, and it would be particularly valuable to have such a method that would not involve changing the manufacturing process significantly. Furthermore, such a method should use a warning device that does not endure the highest temperatures of the heating element of the smooth cooktop stove so that it can utilize less expensive and more commonly available thermochromic compositions.

The presents invention provides such a method and offers other advantages too.

The present invention is also applicable, not just to stoves and related appliances, but to any other surface that one may need to be warned that it is hot. There are numerous devices whose surfaces become hot and remain hot even after the device has been shut off either electrically or otherwise. For example, a radiator cap becomes hot when the vehicle and radiator shut off. Also, any kind of piping that is a conduit for hot liquids is an example of a surface that one may need to be warned that it is hot. Other devices having hot surfaces include hot surfaces on fireplace doors, radiator caps, irons, chafing dishes, coffee urns, heating pipes, home radiators, glue guns, oven doors, portable heaters of electric, oil and ceramic disc, kerosene lamps, kerosene heaters, barbecue grills of electric, gas or coal, electric woks, electric skillets, deep fryers for home or commercial use, heat lamps in self service cafeterias and salad bars, saunas including the metal box that generates and/or controls the heat, rotisseries, indoor grills whether gas or electric, tea kettles, wood burning stoves, hot electric rollers, hot wax holders used for beauty treatments, bonnet type hair dryers, curling irons, portable generators, steam cleaners especially such as in dry cleaning facilities, hot water pipes that are exposed, hot water heaters, furnaces, warming trays, light fixtures such as halogen lamps, popcorn makers (especially commercial ones), toasters, cappucino and espresso makers, autoclaves used to sterilize instruments in a medical setting, movie projectors and other such hot surfaces. These and other hot surfaces are exposed to children, maintenance works and ordinary adult users.

Other embodiments of the present invention are also needed. Accordingly, there is a need for a versatile, easily movable and mountable, removably attachable and detachable, and effective, convenient and easy to manufacture device for warning adults, workers and children instantly when any kind of surface, whether it be a stove of any kind or any other surface, is too hot to touch. There is also a need for such a device that is both capable of installation on a previously purchased stove of any known type, including cooktops, electric and gas stoves, and one that is also capable of being manufactured as part of the stove by stove manufacturers. The present invention addresses and satisfies all of these needs and provides other advantages.

There is also a need for an effective, convenient and east to use and detachable heat alert safety device that is easily read and understood for warning adults and children when any surface is too hot to touch. Such a device should ideally be positionable at a variety of heights or positions so that it can be custom tailored for children of different height.

In order for the heat alert safety device of the present invention to be effective it has to be visible (or at least discernable) and in addition it should be discernable and effective for children; and since children of different ages are of different heights it is advantageous to be able to attach the device to. It is also necessary because a particular individual may decide to relocate the heat alert safety device when a different appliance is used or when a different portion of a kitchen counter is used, or when any other object with a hot surface is activated. It should be noted that by “activated” is included situations when an object is “hot” a certain amount of time after the source of the heat was “on” and it is of course not intended that the device of the present invention is limited to situations when electricity is “on” for an appliance or other object.

### SUMMARY OF THE INVENTION

The present invention is a method of warning individuals about hot surfaces of stoves, including smooth cooktop stoves, electric and gas stoves. The method uses involves applying a ring element of thermochromic composition directly to the top surface of the top stove for each heating element of the stove. The thermochromic composition changes color and remain at that color when the surface of the heating element or surrounding area exceeds a certain temperature. The thermochromic composition is typically liquid crystal compositions, liquid crystal polymers designed to turn color when they reach a certain temperature. The ring element can have an interrupted area that includes an outline of a heat symbol such the letters “HOT”.

The method of the present invention uses thermochromic ink or epoxy material in the form of a heat warning symbol that is directly applied to a hot surface such as by being sprayed, stamped, stenciled, silk screened, embossed to the hot surface of the appliance. For example, the letters “HOT” are a common type of heat warning symbol. The device used in the method of the present invention is invisible when “cold” (i.e. when not hot enough to be considered too hot to touch or dangerously hot) and is visible when a threshold temperature is reached. In a second version when not dangerously hot the device shows only the outline of the heat warning symbol and when hot shows the full symbol.

A plurality of these versions of the thermochromic composition can be placed on various parts or surfaces of an appliances or other hot surfaces to maximize the effectiveness of the warning system and to tailor the heat alert warning system to both children, who need guidance as to where to look for said warning symbols, and to adults, as to whom the impact is greatest when the warning symbol appears after being invisible.

The thermochromic composition and device is entirely constructed out of material able to withstand repeated cycling to particular temperatures in the range of approximately 300 to 500 degrees Fahrenheit or more, and able to withstand rough treatment.

### OBJECTS AND ADVANTAGES

The following important objects and advantages of the present invention are:

(a) to provide a method of warning individuals about the hot surfaces of stoves that employs heat warning symbols that are specific to each heating element;

(b) to provide a method of warning individuals about the hot surfaces of stoves that employs heat warning symbols wherein each heat warning symbol is immediately recognizable as being physically associated with a specific heating element;

(c) to provide a method of instantly warns anyone including a child that the surface of a smooth cook stove, electric stove, gas stove, hot plate, the window of a toaster oven, or other hot surface is too hot to touch,

(d) to provide a method of warning individuals about the hot surfaces on a smooth cook top stove that instantly displays to anyone the letters “HOT” as a warning on the surface of a stove,

(e) to provide such a method that instantly provides a warning display to anyone using the letters “HOT” that appears directly on the heating element of the stove surface so that it is clear to anyone what is too hot to touch,

(f) to provide such a method that employs a versatile heat warning device and that can be used for smooth cooktop stoves having any kind of surface including glass or metal and using any kind of technology including electric heating, electric induction and halogen light heating, or can be used for electric stoves, or for gas stoves, for wall ovens, for toaster ovens, for hot plates or for warming trays,

(g) to provide such a method for smooth cooktop stoves having any kind of surface including glass or metal and using any kind of heating technology including electric heating, electric induction and halogen light heating that instantly displays to anyone as a warning on the surface of the stove a ring surrounding each heating element of the stove, which ring may contain in an interrupted area of the ring the letters “HOT”, the ring and letters turning red at a certain temperature of the heating element,

(h) to provide such a method that is easy to perform and that can be include the step of manufacturing a smooth cook top stove or that can include the step of installing on to a pre-existing smooth cooktop a warning device in accordance with the present invention,

(i) to provide such a method that applies to the stove a heat warning device that can be calibrated to signal the word “HOT” or in the case of cooktop stoves to light up a ring around the heating element only when a certain temperature, such as 115 degrees Fahrenheit, is reached and that can remain in signaling mode as long as such temperature is exceeded by the appliance surface,

(j) to provide a method that uses a heat warning device that makes use of liquid crystals that change color when a certain temperature is reached, such as cholesteric liquid crystals or various types of liquid crystal polymers designed to change color when a certain temperature is reached,

(k) to provide a method of warning individuals about the hot surfaces of stoves that employs configurations of thermochromic composition that form a ring around the heating element;

(l) to provide a method of warning individuals about the hot surfaces of stoves that employs configurations of thermochromic composition that form a partial ring or an arc around the heating element;

(m) to provide a method of warning individuals about the hot surfaces of stoves that employs configurations of thermochromic composition that form an arrow pointing to the heating element; and

(n) to provide a method of warning individuals about the hot surfaces of stoves that employs configurations of thermochromic composition that form a line surrounding the heating element.

### BRIEF DESCRIPTION OF THE DRAWINGS

FIG. 1 is an enlarged fragmentary plan view of one heating element of a smooth cook top stove and having the device used in the method of the present invention in the shape of an interrupted ring surrounding the heating element.

FIG. 2 is a enlarged fragmentary cross-sectional view taken along line 2-2 of FIG. 6 and/or line 2-2 of FIG. 1.

FIG. 3 is an enlarged fragmentary plan view of one heating element of a smooth cook top stove having the device used in the method of the present invention.

FIG. 3A is a top plan view of the smooth cook top stove referred to in FIG. 3.

FIG. 4 is a enlarged fragmentary cross-sectional view taken along line 4-4 of FIG. 3.

FIG. 5 is an enlarged fragmentary plan view of one heating element of a smooth cooktop stove and having the device used in the method of the present invention in the shape of a ring surrounding the heating element.

FIG. 6 is a fragmentary plan view of an alternative embodiment of the heat warning safety device used in the method of the present invention;

FIG. 7 is a fragmentary plan view of an alternative embodiment of the heat warning safety device used in the method of the present invention;

FIG. 8 is a fragmentary plan view of an alternative embodiment of the heat warning safety device used in the method of the present invention;

FIG. 9 is a fragmentary plan view of an alternative embodiment of the heat warning safety device used in the method of the present invention;

FIG. 10 is a fragmentary plan view of an alternative embodiment of the heat warning safety device used in the method of the present invention;

FIG. 11 is a fragmentary plan view of an alternative embodiment of the heat warning safety device used in the method of the present invention;

FIG. 12 is a fragmentary plan view of an alternative embodiment of the heat warning safety device used in the method of the present invention;

FIG. 13 is a fragmentary plan view of an alternative embodiment of the heat warning safety device used in the method of the present invention;

FIG. 14 is a fragmentary plan view of an alternative embodiment of the heat warning safety device used in the method of the present invention; and

FIG. 15 is a fragmentary plan view of an alternative embodiment of the heat warning safety device used in the method of the present invention.

### DETAILED DESCRIPTION OF THE DRAWINGS

The present invention is a method of warning individuals that a top surface of a smooth cooktop stove or the top surface of an electric stove or of a gas stove is hot. In one preferred embodiment with respect to a smooth cooktop stove the method comprises the steps of (a) manufacturing a smooth cooktop stove of a type having a plurality of heating elements each heating element comprising a smooth area of glass or metal that is subjected to a heat source from underneath said area, the smooth area of glass of each heating element forming a portion of a smooth top surface of the stove, and then (b) applying to a portion of the smooth top surface of the smooth cooktop stove a thermochromic composition in liquid or semi-liquid state in a form of a ring element outside each smooth area of glass or metal. The thermochromic composition that is applied is designed to undergo and maintain a readily perceptible color change whenever and so long as a part of either the heating element or surrounding area on the top surface of the smooth cooktop stove exceeds a predetermined temperature, the color change of the thermochromic composition revealing a heat warning symbol that communicates that the top surface of the stove is dangerously hot, and then (c) allowing the thermochromic composition to dry to a solid state. If one begins with an already existing smooth cooktop stove, then step (a) is unnecessary and the method begins with step (b) described above. In accordance with the method, a separate thermochromic composition reveals a separate heat warning symbol that is immediately recognizable as being associated with a particular heating element because it is physically associated with that heating element on the stove.

The phrase “liquid or semi-liquid” is intended to include, but is not necessarily limited to, anything that can be sprayed, printed, embossed, written, stenciled, silkscreened or stamped onto a surface.

It is noted that although the method has been described in terms of warning individuals about hot surfaces on smooth cooktop stoves, and in fact FIG. 5 illustrates such a stove, the method of the present invention can in fact be used just as well with electric, gas and other stoves having a top surface that has a smooth or relatively smooth portion surrounding each of the one or more heating elements. In this context, the term “smooth” when describing the top surface of a stove (other than a smooth cooktop stove) is a broad term and is intended to broadly encompass any such top surface that is generally relatively smooth in portions of the top surface that are surrounding the heating elements.

Thus, the general method involves (a) manufacturing a stove of a type having a plurality of heating elements each heating element surrounded by a smooth area of glass or metal in the top surface, and then for each heating element

(b) applying to a surrounding smooth area, which surrounding smooth area represents a portion of the top surface of the stove that surrounds the heating element, a thermochromic composition in liquid or semi-liquid state in a form of a ring element. The thermochromic composition that is applied is designed to undergo and maintain a readily perceptible color change whenever and so long as (any part of ) either the heating element or the surrounding smooth area exceeds a predetermined temperature, the color change of the thermochromic composition revealing a heat warning symbol that communicates that the heating element or the surrounding smooth area on the top surface of the stove is dangerously hot, and then

(c) allowing the thermochromic composition to dry to a solid state.

If one begins with an already existing stove, then step (a) is unnecessary and the method begins with step (b) described above.

The ring element can be and is defined as including a ring, a partial ring, an arc or even a line of thermochromic composition surrounding each of the heating elements of the stove. In addition, the thermochromic composition can alternatively be in the form an arrow pointing to the heating element. Hence the term “ring element” is used to include a ring, a partial ring, an arc or a line surrounding the heating element as well as an arrow pointing to the heating element. Furthermore, the ring element can include or be interrupted by a word or other symbol such the letters “HOT”. In this context, as further explained below, “thermochromic composition” here, and in every explanation of the breadth of the definition of a “ring element” herein, means either the composition in that shape (of the ring element) or that the heat warning symbol revealed by the thermochromic composition when the composition turns invisible is in that shape.

The ideal heat warning symbol is in a color known to represent warning, such red or orange, although the heat warning symbol can be in any color in accordance with the present invention.

It should be understood clearly that the thermochromic composition of the present invention reveals a predetermined symbol whenever and so long as the temperature of the surface that the composition is on exceeds a predetermined temperature. This can be arranged in more than one way. For example, this can happen as a result of the thermochromic composition turning color and being shaped in the shape of the heat warning symbol (or the background of such symbol). It can also happen as a result of the thermochromic composition covering the heat warning symbol and then becoming invisible at the triggering temperature to reveal a separate heat warning symbol that is underneath the thermochromic composition.

In either case, the thermochromic composition, when the triggering temperature is reached, simply turns into a color that makes the symbol readily visible. For example, the thermochromic composition can turn red at the triggering temperature and be shaped in the form of the symbol or shaped in the background of the symbol. The second way is that the thermochromic composition, until the triggering temperature occurs, blocks the visibility of a red heat warning symbol underneath it. When the triggering temperature arrives, the thermochromic composition becomes invisible and reveals the underlying red symbol.

In either case, it is preferable that the entire heat warning symbol and the thermochromic composition be substantially invisible against a background color of the surface (surrounding smooth area) prior to the triggering temperature being exceeded due to the thermochromic composition being sufficiently similar in color to the color of the surrounding smooth area. This is so that the presence of the heat warning device be unknown prior to the triggering temperature being exceeded. This has two advantages: (i) the warning is more dramatic when it arrives and (ii) the presence of the warning does not clutter or mar the appearance of the surface of the stove or other appliance

In the case where the thermochromic composition covers a previously written or formed heat warning symbol, preferably, the heat warning symbol was formed or written underneath the thermochromic composition by whatever well known processes employ the least expensive means, such as printing, writing, stamping, scratching, etc. Accordingly, although the drawing figures of the present invention may seem to be directed to the case in which the thermochromic composition is itself in the shape of the letters “H,O,T” or other heat warning symbol, it should be understood that the drawings could just as well be depicting the case in which the thermochromic composition has turned invisible (since the temperature has exceeded the predetermined temperature) and has revealed beneath said composition the heat warning symbol such as the letters “HOT” printed or otherwise fixed onto some tangible medium of expression such as paper or any other object.

It is to be understood that a heat warning symbol (sometimes called a “heat symbol”) can take multiple forms and is not limited to the letters “HOT”. The present invention contemplates that other letters and other letter shapes besides that of “HOT” could be used as a warning symbol although it is believed that the simple arrangement of the letters “HOT” in a bold simple typeset provide the best warning symbol. The symbol may also take the form of a exclamation point, an international “no” symbol superimposed on a stick diagram of a figure touching a surface, a stylized human face showing shock or pain, a representation of flames, or any other recognizable warning symbol. Furthermore, the present invention also contemplates that the thermochromic composition in the outline of the letters “HOT” can be embedded in a surface of a stove, toaster oven or other appliance where the surface is vertical and perpendicular to the floor, not only horizontal. In addition, while the drawings depict the thermochromic composition embedded on the surface of the stove in a particular configuration and depth, it is contemplated by the present invention that the depth and configuration of the thermochromic composition can vary and still be within the scope of this invention.

In some embodiments, when the temperature of the surface does not exceed the predetermined temperature the thermochromic composition is not readily visible against a background color of the hot surface. This further dramatizes the appearance of the warning symbol when the temperature does exceed the predetermined temperature.

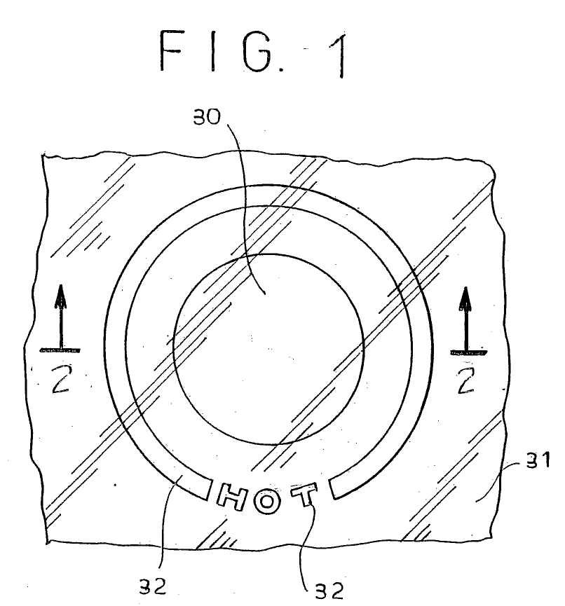

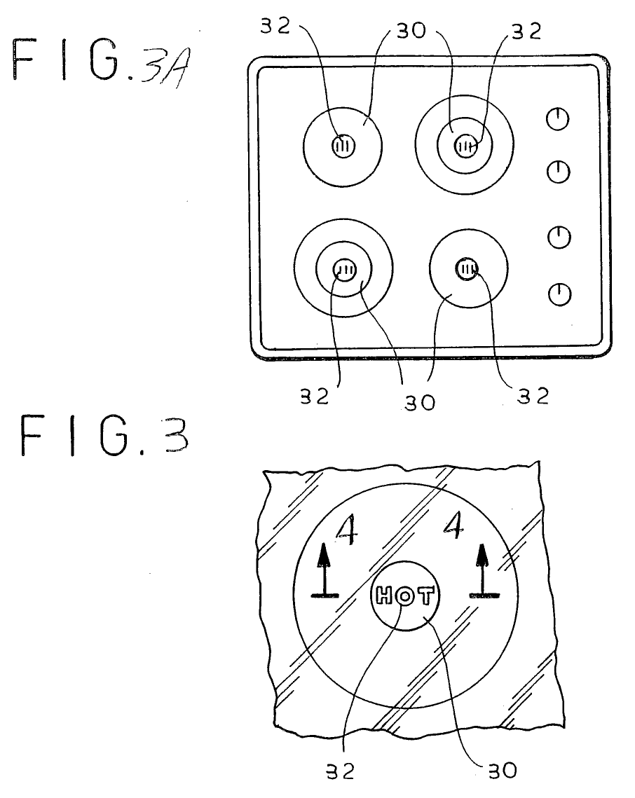

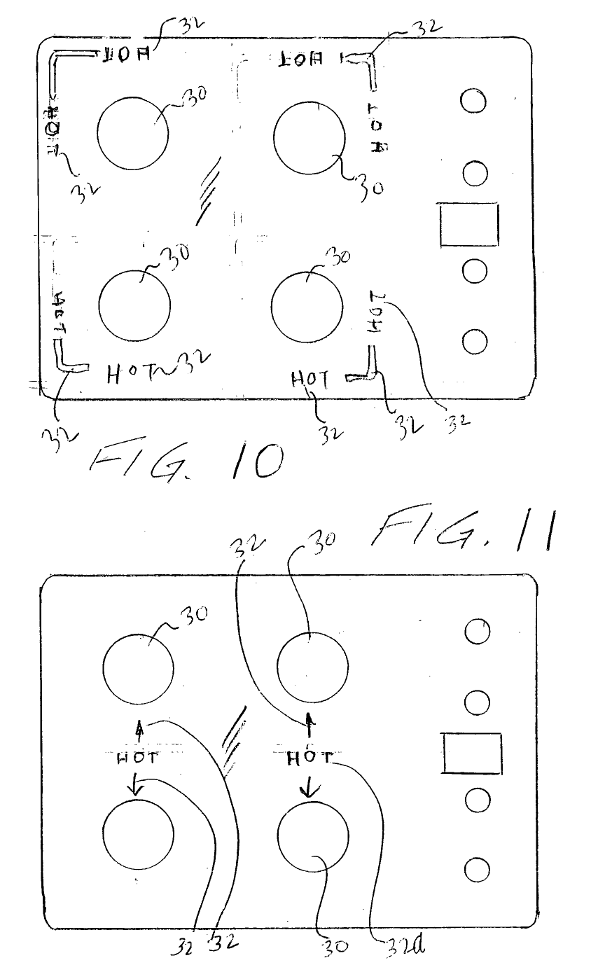

FIGS. 1-5 herein depict an embodiment of the present invention for use with smooth cooktop stoves, sometimes called “smoothtops” or “cooktops”. For cook top stoves, the prior art is shown in FIG. 4 of U.S. Pat. No. 6,104,007 to Lerner. As seen in FIGS. 1-6 of the present invention herein, smooth cooktop stoves have heating elements that consist essentially of an area of glass surface 30 that is smooth on top and whose underside is made dark enough to absorb light. Such absorption generates heat in the smooth area of glass 30. Underneath each area 30, usually circular, is a strong light source 36, such as a halogen lights. The light source 36, as seen in FIG. 10 of U.S. Pat. No. 6,104,007, projects the light upward to the surface area of the smoothtop's heating element—the glass area 30 on the top surface of the stove. Since each glass area is coated on its bottom with a dark coating, when the light strikes it, the heat from the strong light is absorbed by the darkened portion of the smooth area of glass 30. These glass surfaces 30 form the heating elements of the stove. For cooking, cooking utensils are simply placed over the area (which may be square, round, etc.) of the heating element on the glass surface. Some smooth cooktop stoves employ “radiant” heat sources for the glass areas instead of halogen light sources 36 but the effect is the same. In addition, some smooth cooktop stoves have halogen lamps (under each area 30 as before) but they emit infrared waves that provide light and heat.

The heat alert device used in the method of the present invention when used for the smooth surface of cooktop stoves of either type would comprise thermochromic composition 32 applied directly to an area surrounding the top surface of each glass area 30, which is the heating element on the smooth cooktop stove using known methods. For example, the liquid crystal composition 32 may be made in the exact shape of the letters “HOT” by spraying the composition of liquid crystals 32 over each glass area 30 after covering the glass area 30 with a cardboard stencil or other cut-out in the outline or shape of the letters “HOT”. As before, the liquid crystal composition is designed to turn red (or another color) and remain red (or that other color) whenever the temperature of the smooth area of glass exceeds a specified temperature, such as 115 degrees Fahrenheit.

As an alternative to the second embodiment, for smooth cooktop stoves using any technology including electric heating, electric induction and halogen light heating, and for other kinds of stoves, the liquid crystal display is in the shape of a ring (or ring element) surrounding the heating element (and visible when pots are placed on the heating element) which ring (or ring element) may have an interrupted area in the outline of the letters “HOT”, as seen in FIG. 1. This addresses and solves the problem that people often leave pots or kettles on the stove perpetually and that with cooktop stoves the result of doing so is that the heating element is no never visible (since the pot or kettle may be as large or large than the heating element). In such situations, no matter how mature, cautious and alert you are, you cannot readily ascertain that the heating element (and the kettle or pot above it) is too hot to touch. By seeing the ring element of the present invention (with or without the letters “HOT” filling an interrupted portion thereof) lit up as red, you immediately know that the area of the heating element is too hot to touch. In this embodiment, the liquid crystal composition 32 is embedded on the stove surface in the outline of a ring element (and in the letters “HOT”) in a location of surrounding the heating element, i.e. surrounding the top surface of the smooth glass or metal areas 30 on the stove surface 31.

Although FIGS. 1-5 have been described in terms of smoothtops with heating elements made of smooth glass surfaces, other variations of smooth top stoves exist—in particular smooth metal tops called electric cooktops. The difference is that a light source 36 would not be used under the surface to generate heat—instead the metal gets hot by being connected to a heat source that may be electric (not shown). In addition, some smooth cooktops use a “ribbon heating element” instead of halogen light sources where the smooth glass surface is heated by a coiled electric circuit called a “ribbon element” directly and immediately underneath the glass instead of by a halogen light source. The device of the present invention works the same way for metal cooktops, glass cooktops and for those that rely on halogen light source as the heat or those that use ribbon heating elements. FIGS. 1-5 which depicts the present invention for use with glass cooktops also depicts the present invention as applied to smooth metal cooktop stoves and as applied to ribbon heating elements. FIG. 1-5 can describe the present invention for use with glass cooktops that employ halogen light sources, and can also depict a cross section of the liquid crystal composition for smoothtops—for metal cooktops and glass cooktops using ribbon heating elements the halogen light source 36 would not be present but everything else would be the same. For all of the smooth cooktops, the liquid crystal composition 32 would still be embedded in the top surface of the smooth metal areas 30 on the stove surface in the shape of the letters “HOT”.

Other variations of smooth cooktops also exist and the liquid crystal composition in the shape of the letters “HOT” can also be embedded in their surfaces. For example, some smooth cooktops have a raised solid element having a smooth top and made of metal having a recessed central area. The liquid crystal composition would be embedded in this recessed central area as before in the shape of the letters “HOT”.

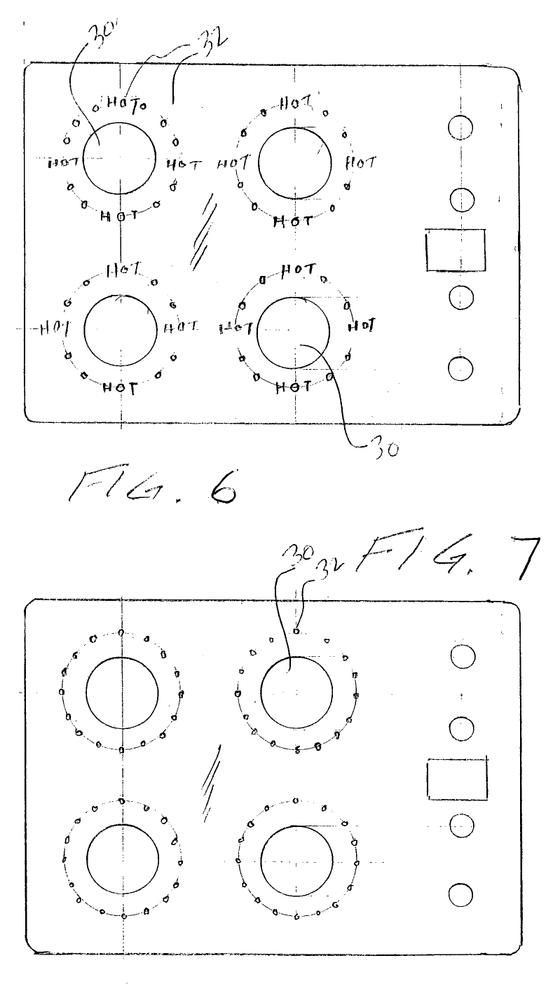

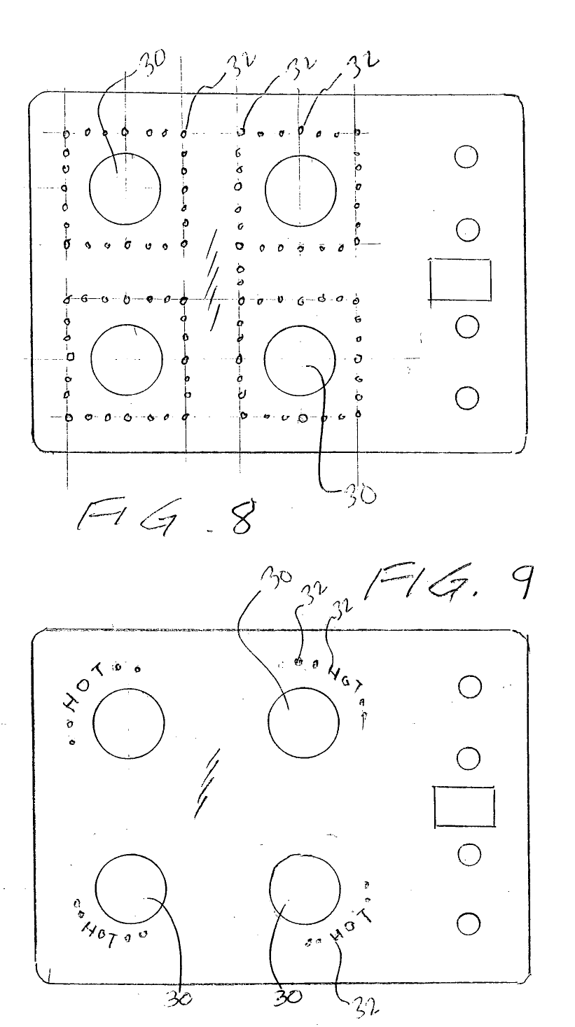

FIGS. 6-15 depict a smooth cooktop stove wherein heat warning symbols appear surrounding the heating element in a variety of configurations. In some of the configurations, the letters “HOT” appear as a portion of the configuration. These configurations are configurations of thermochromic composition applied to the surface of the cooktop stove as part of the method of the present invention. FIGS. 6, 7 and 8 are alternative ways of forming a ring element of thermochromic composition surrounding the heating element. As best seen in FIGS. 9, 10 and 14, which figures depict “partial rings” or arcs of thermochromic composition around the heating element of the smooth cooktop or other stove. In these embodiments of the present invention, partial rings or arcs of thermochromic composition are applied to the smooth top surface of the stove in liquid or semi-liquid state surrounding the heating element. Similarly, FIGS. 11-13 depict arrows of thermochromic composition pointing to the appropriate heating element. Finally, FIG. 15 depicts the thermochromic composition in the shape of a line surrounding the heating element it is warning about.

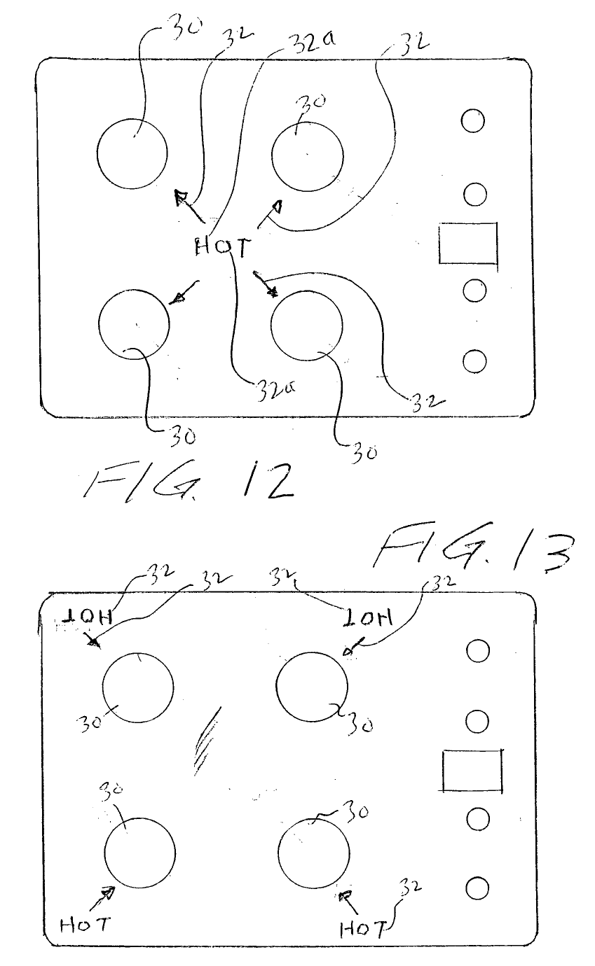

For all of the figures and configurations, the thermochromic composition can include recognized word strings or other recognized heat warning symbols such as the letters “HOT” in any portion thereof, or in the case of the arrow, alongside the arrow. Furthermore, in certain embodiments, as seen in FIG. 11 and FIG. 12, the adjunct word string or other warning symbol (for example the letters “HOT”) can be associated with more than one arrow since each arrow itself individually points to an individual heating element. Accordingly, it should be clearly understood that for all of the embodiments of the method of the present invention, even though the methods are formulated into steps taken to apply thermochromic composition “for each heating element”, and in even though in FIGS. 11 and 12 a portion of the thermochromic composition or underlying symbol is in common to more than one heating element, the methods are intended to include the situations depicted in FIGS. 11 and 12 where a portion of the thermochromic composition (or underlying warning symbol) is in common to more than one heating element. It is noted that even in FIGS, 11-12 at least a portion of the thermochromic composition (or underlying warning symbol) is unique to each heating element, i.e. the arrow. In this case a further step at the end of or in the midst of the portion of the method involved with application of the thermochromic composition is added which further step involves applying an adjoining element 32a of thermochromic composition (for example the letters “HOT” adjoining more than one arrow) adjoining more than one of the ring elements, the adjoining element itself being used with or as part of the heat warning symbol of more than one heating element of the stove.

In general, the method of the present invention is applied to a stove of a type having a plurality of heating elements. In the case of a smooth cooktop stove each heating element comprises a smooth area of glass or metal that is subjected to a heat source from underneath the area, and the smooth area of glass of each heating element forms a portion of the smooth top surface of the stove. The surfaces of smooth cook top stoves get very hot. Accordingly, having the thermochromic composition directly on the heating element would require thermochromic compositions that are not widely available or that would be difficult and/or expensive to manufacture. This is because the thermochromic composition has to withstand repeated cycling below and above the temperature that triggers a change in color. Accordingly, the present invention makes use of thermochromic compositions in a ring element surrounding the heating element of the smooth cook top stove. The distance between the thermochromic composition and the heating element of the smooth cook top stove is preferably approximately half an inch to approximately two inches. The present invention contemplates that it could also be greater than approximately two inches.

When the thermochromic composition is applied by being sprayed, stenciled, embossed, stamped, silk screened, printed or otherwise applied to the surface 30, the composition 20 is typically applied initially in a liquid or semi-liquid form. Only then it dries or dries instantly. The term “semi-liquid” is a broad term intended to encompass a malleable solid form. Accordingly, thermochromic composition 20 is capable of being applied as a liquid or semi-liquid directly to the surface 30 in the predetermined shape and it is capable of remaining on surface 30 in its predetermined shape in solid form after being left to dry. It is capable of withstanding temperatures in excess of 500 degrees Fahrenheit in certain embodiments. The present invention, however, does contemplate applying the thermochromic composition in some manner that said composition is immediately or almost immediately in essentially solid form.

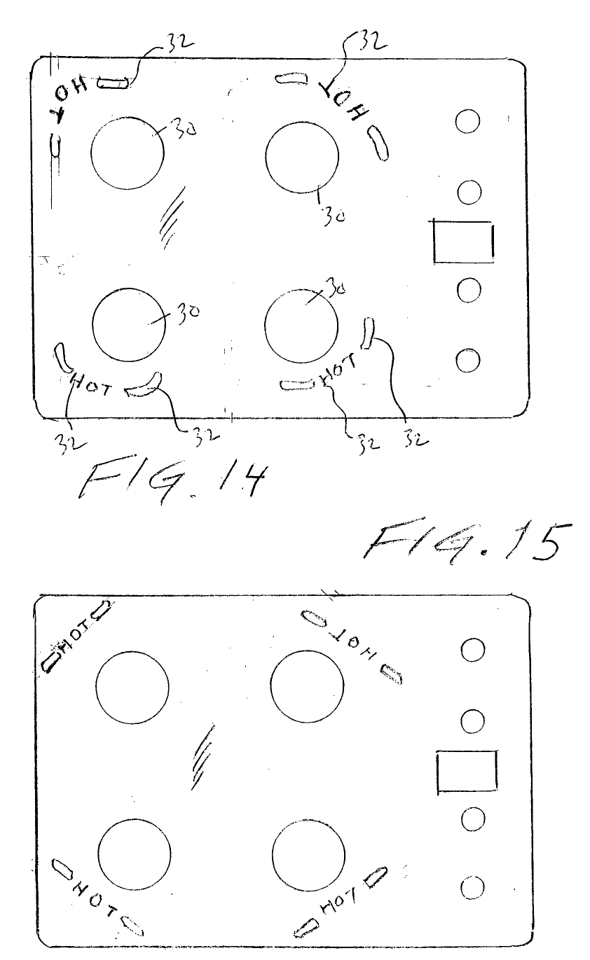

Although the ring element of thermochromic composition that includes or that in some embodiments itself constitutes the heat warning symbol is generally depicted in the drawing figures as a circular ring, the term ring which is one example of the ring element used in the method of the present invention should be understood to mean something broader that merely a circle. For example, the ring referred to can just as well be a square, triangle, pentagon or other polygon or even a combination of lines and curves. Similarly, the arc, which is a second example of the ring element used in the method of the present invention, should be understood to mean something broader than merely a traditional arc. For example, as seen in FIG. 9 and FIG. 14, the arc can just as well be an “L” shaped combination of two lines with or without a rounded intersection point.

Furthermore, although a ring, an arc or a line (or an arrow) is generally thought of as being entirely continuous, as seen in FIG. 9, the “ring element” of the present invention definitely contemplates that there could be gaps in the continuity of the ring element even if said gaps do not form part of the heat warning symbol and are not necessary to spell out a heat warning symbol. In other words, in addition to the fact that there would typically be a gap between the letters “H, O, T” if the heat warning symbol were made of said letters, there could also be other gaps in the continuity of the ring element, as shown for example in FIG. 9.

Furthermore, the term “ring element” also contemplates rings, partial rings, lines or arcs of thermochromic composition surrounding the heating element (as well as arrows pointing to the heating element) that comprise only the letters “HOT”, or only any other visual symbol recognized as a heat warning symbol.

As previously explained, in a preferred embodiment, the thermochromic composition turns invisible at the triggering temperature and reveals the heat warning symbol underneath the composition. In the present invention it is advantageous to not have to modify the manufacturing of the ordinary smooth cooktop stove significantly and it is preferable to maintain the essentially smooth surface of the smooth cooktop stove even after the thermochromic composition (or such composition and the heat warning symbol) has been installed/applied onto the smooth top surface of the smooth cooktop stove.

Accordingly, in cases when the thermochromic composition turns invisible at the triggering temperature (as opposed to turning to a visible color and the composition itself being in the shape of the heat warning symbol) the underlying heat warning symbol can be present in the following way without marring the essentially smooth top surface of the stove and without altering the ordinary manufacturing of the smooth cooktop stove. One way is to simply have the letters “H,O,T” or other heat symbol sprayed on over a stencil, onto the smooth cook top surface using liquid that is not thermochromic—just ordinary paint or spray that is capable of withstanding high temperatures, such as sprayable epoxy resin, epoxy paint or ink. It need not be thermochromic. Then on top of that layer, one can simply apply by any well known process directly on to the surface a layer of thermochromic composition in the form of ink or epoxy resin in a form that entirely covers the heat warning symbol.

Alternatively, the thermochromic composition can be located on a thin surface or object. The surface can be a layer of aluminum foil or other thin metal, colored enamel, colored aluminum, or any other object or surface that can be written on and that can withstand the heat of several hundred degrees Fahrenheit. Ideally, the heat warning symbol has a reflective quality to increase visibility. There are well known means to make lettering have a reflective surface—it could be the reflective quality of the foil, it could be a holographic effect or any other means well known in the art.

Accordingly, the method of the present invention can also be described as a method of warning individuals that a top surface of a stove is hot, the stove of a type having a plurality of heating elements each heating element surrounded by a smooth area of the top surface, such as glass or metal, the method comprising, for each heating element (a) applying to a surrounding smooth area, which surrounding smooth area represents a portion of the top surface of the stove surrounding the heating element, a heat warning symbol that communicates that part of the heating element or the surrounding smooth area is dangerously hot, said heat warning symbol being able to withstand the temperature of least 300 degrees Fahrenheit, (b) applying to the surrounding smooth area a thermochromic composition in liquid or semi-liquid state in a form of a ring, the thermochromic composition designed to undergo and maintain a readily perceptible color change whenever and so long as a part of either the heating element or the surrounding smooth area exceeds a predetermined temperature, the color change of the thermochromic composition revealing the heat warning symbol, and allowing the thermochromic composition to dry to a solid state.

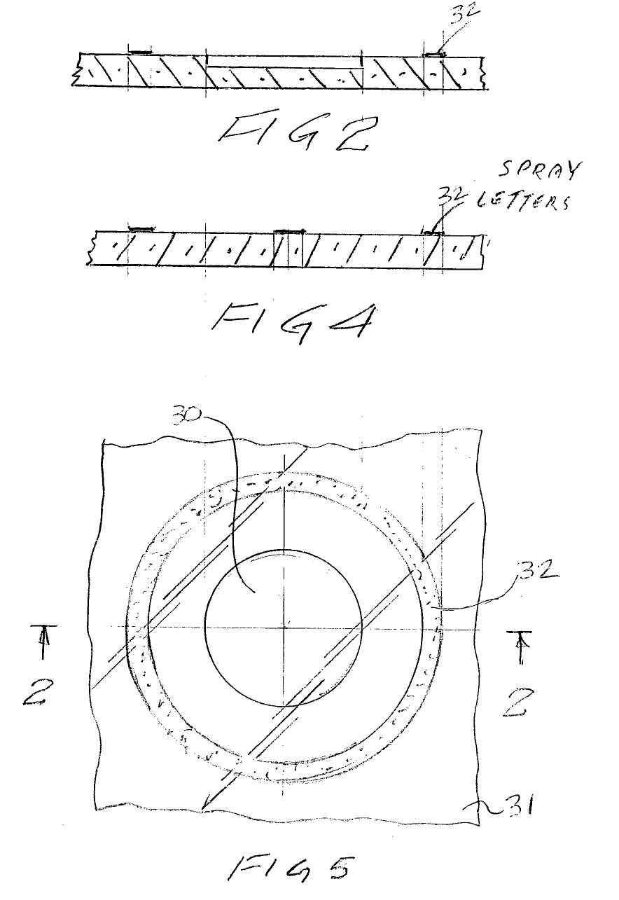

The thermochromic composition on the smooth cooktop or other stove is very thin. It has the thickness of written ink embossed, sprayed or otherwise applied to a smooth surface. For example, a smooth surface of an appliance may have embossed thereon a particular logo or product name. If an individual were to close his eyes and feel that surface they would be able to feel the raised ink but only barely. Accordingly, the thickness in solid form of thermochromic composition 20 is such that the thermochromic composition is either faintly visible or invisible when viewed from a line of light tangent to the surface 30 by someone whose attention is not specifically directed to said thermochromic composition. Although FIGS. 2 and 4 do show a visible surface, that is simply to illustrate the fact that there is at least some thickness and is not intended to be to scale.

Typically, composition 20 is applied as a liquid directly to the surface by being sprayed, stamped, stenciled, printed, embossed or silk screened onto said surface. Thermochromic compositions that are suitable are well known and include inks and epoxy resins. For example, the following are examples of thermochromic compositions made by various companies that are applicable to the present invention. Hallcrest, Inc. makes color change products that are temperature sensitive. For example, Hallcrest, Inc. manufactures microencapsulated thermochromic liquid crystal slurries and sprayable microencapsulated thermochromic liquid crystal coatings. Chromatic Technologies, Inc. manufacturers Dynacolor® Resin for epoxy screen ink. Matsui International Company, Inc. manufacturers a product called Chromicolor® which is an epoxy resin spray paint.

By applying the thermochromic composition on the top surface of the cook top stove, instead of embedding it underneath the surface in a bulky surrounding, the device of the present invention can be easily integrated into the existing manufacturing process used to make smooth cook top stoves. The glass surface of the stove with its heating elements are manufactured the way they would be made without the device of the present invention. Afterwards, the thermochromic composition can be directly applied on to the top surface of the smooth sook top stove as explained, by spraying, etc. This is an inexpensive intrusion into the manufacturing of the smooth cooktop stove yet it provides the advantages of having a heat warning device.

Furthermore, since the heat warning device is not embedded below or well below a glass surface, it can be seen more visible from a wider range of angles.

It should be noted in general that the present invention makes use of any liquid crystal composition that changes color and remains at that color when a specified temperature is reached or exceeded—it need not necessarily be cholesteric, although it has been found that cholesteric liquid crystals do this effectively. It is also within the scope of the present invention to make use of a liquid crystal composition that changed color when it reached a specified temperature or temperature range but changed to a third color at a higher threshold temperature, so long as the third color is significantly different from the first color—although this would certainly not be the ideal kind of liquid crystal composition. The ideal composition turns red at a specified temperature and remains red above that temperature.

With use of the present invention, when an individual enters the kitchen with the cook top stove in it he or she can instantly recognize if any of the heating elements are too hot. This is in contrast to the prior art for which the person would have to first figure out which heating element corresponds to which light indicator.

The present invention contemplates that other letters and other letter shapes besides that of “HOT” could be used as a warning although it is believed that the simple arrangement of the letters “HOT” in the simplest typeset provide the best warning. Furthermore, the present invention also contemplates that the liquid crystal composition in the outline of the letters “HOT” can be embedded in a surface of a stove, toaster oven or other appliance where the surface is vertical and perpendicular to the floor, not only horizontal. In addition, while the drawings depict the liquid crystal composition embedded on the surface of the stove in a particular configuration and depth, it is contemplated by the present invention that the depth and configuration of the liquid crystal composition can vary and still be within the scope of this invention.

It is also contemplated by the present invention that glass disks containing liquid crystal compositions in the shape of the letters “HOT” can be made so as to be purchased separately by the consumer as a glass disk having embedded therein the liquid crystal composition to be affixed to a glass surface area of a cooktop stove, a wall oven or a toaster oven.

It is also contemplated by the present invention with respect to all embodiments that in addition to the liquid crystal composition conveying the outline of the letters “HOT” by being in an outline of the letters “HOT”, the liquid crystal composition could instead convey the outline of the letters “HOT” by being in the background of such an outline. By this is meant that the liquid crystal composition would form the entire area except an outline of the letters “HOT”. The point of one feature of the present invention is to use the liquid crystal composition to create a color contrast between red and some other color in order to depict the letters “HOT” in red whether by virtue of the liquid crystal composition itself being the letters “HOT” or whether the liquid crystal composition surrounds the letters and in effect constitutes everything else except the letters “HOT” or whether the thermochromic composition covers a previously inscribed symbol and becomes invisible to reveal such symbol at the triggering temperature. Furthermore, it should be noted that in this patent application, the term “red” refers to all possible variations and shades of the color red as well as to all possible variations of the color orange. Red and orange are the colors associated with heat. Furthermore, if the hot surface (as opposed to the area of the liquid crystal composition) itself is or becomes red when hot, then the liquid crystal composition 230 would have to be orange and vice versa.

The term “stove” or “stoves” is broadly intended to also include so-called cooktops which is a word commonly used to denote heating appliances that have no oven but only have the top surface of a stove with the plurality of burners on its top surface. The term “stove” or “stoves” also includes smooth cooktop stoves which may or may not have ovens. The term “stoves” also includes “mobile stove-type appliances” such as hot plates and warming trays.

In general, it is to be understood that while the method of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof It is not desired to limit the invention to the exact steps of the method shown or described nor to the exact construction and operation of the apparatus shown and described and used in such steps of the method. The spirit and scope of this invention are limited only by the spirit and scope of the following claims.

What is claimed is:

1. A method of warning individuals that a top surface of a stove is hot, the method comprising:
(a) manufacturing a stove of a type having a plurality of heating elements each heating element surrounded by a smooth area of the top surface, such as glass or metal,
(b) for each heating element applying to a surrounding smooth area, which surrounding smooth area represents a portion of the top surface of the stove surrounding the heating element, a thermochromic composition in liquid or semi-liquid state in a form of a ring element, the thermochromic composition designed to undergo and maintain a readily perceptible color change whenever and so long as a part of either the heating element or the surrounding smooth area exceeds a predetermined temperature, the color change of the thermochromic composition revealing a heat warning symbol that communicates that the heating element or the surrounding smooth area is dangerously hot, and
(c) allowing the thermochromic composition to dry to a solid state.

2. The method of claim 1, wherein applying the thermochromic composition means applying the thermochromic composition that is sufficiently similar in color to a background color of the surrounding smooth area that the thermochromic composition and the heat warning symbol are readily visible against the background color of the surrounding smooth area only when and so long as the temperature of the surface exceeds the predetermined temperature.

3. The method of claim 1, wherein applying the thermochromic composition in the form of a ring element means applying said thermochromic composition in the form of a ring element at a distance of between approximately one half an inch and approximately two inches from the smooth area of glass or metal.

4. The method of claim 1, wherein the applying of the thermochromic composition is performed by spraying, stamping, printing, stenciling, embossing or silk screening the thermochromic composition onto the portion of the smooth top surface.

5. The method of claim 1, wherein the applying of the thermochromic composition involves applying thermochromic composition that is ink or epoxy resin.

6. The method of claim 4, wherein the applying of the thermochromic composition involves applying thermochromic composition that is ink or epoxy resin.

7. The method of claim 6, wherein applying the thermochromic composition in the form of a ring element means applying said thermochromic composition in the form of a ring element at a distance of between approximately one half an inch and approximately two inches from the smooth area of glass or metal.

8. The method of claim 1, wherein applying the thermochromic composition in the form of a ring element means applying said thermochromic composition in the form of a ring element that has at least one interrupted portion thereof, said at least one interrupted portion including a symbol that conveys that the top surface is dangerously hot

9. The method of claim 8, wherein applying the thermochromic composition in the form of a ring element means applying said thermochromic composition in the form of a ring element at a distance of between approximately one half an inch and approximately two inches from the smooth area of glass or metal.

10. The method of claim 8, wherein the applying of the thermochromic composition is performed by spraying, stamping, printing, stenciling, embossing or silk screening the thermochromic composition onto the portion of the smooth top surface.

11. The method of claim 8, wherein the applying of the thermochromic composition involves applying thermochromic composition that is ink or epoxy resin.

12. The method of claim 10, wherein the applying of the thermochromic composition involves applying thermochromic composition that is ink or epoxy resin.

13. The method of claim 12, wherein applying the thermochromic composition in the form of a ring element means applying said thermochromic composition in the form of a ring element at a distance of between approximately one half an inch and approximately two inches from the smooth area of glass or metal.

14. The method of claim 1, wherein in addition to the step of applying the thermochromic composition there is a further step of applying an adjoining element of thermochromic composition adjoining more than one of the ring elements.

15. A method of warning individuals that a top surface of a stove is hot, the stove of a type having a plurality of heating elements each heating element surrounded by a smooth area of the top surface, such as glass or metal, the method comprising:
(a) for each heating element applying to a surrounding smooth area, which surrounding smooth area represents a portion of the top surface of the stove surrounding the heating element, a thermochromic composition in liquid or semi-liquid state in a form of a ring element, the thermochromic composition designed to undergo and maintain a readily perceptible color change whenever and so long as a part of either the heating element or the surrounding smooth area exceeds a predetermined temperature, the color change of the thermochromic composition revealing a heat warning symbol that communicates that the heating element or the surrounding smooth area is dangerously hot, and
(b) allowing the thermochromic composition to dry to a solid state.

16. The method of claim 15, wherein applying the thermochromic composition means applying the thermochromic composition that is sufficiently similar in color to a background color of the surrounding smooth area that the thermochromic composition and the heat warning symbol are readily visible against the background color of the surrounding smooth area only when and so long as the temperature of the surface exceeds the predetermined temperature.

17. The method of claim 15, wherein applying the thermochromic composition in the form of a ring element means applying said thermochromic composition in the form of a ring element at a distance of between approximately one half an inch and approximately two inches from the smooth area of glass or metal.

18. The method of claim 15, wherein the applying of the thermochromic composition is performed by spraying, stamping, printing, stenciling, embossing or silk screening the thermochromic composition onto the portion of the smooth top surface.

19. The method of claim 18, wherein the applying of the thermochromic composition involves applying thermochromic composition that is ink or epoxy resin.

20. The method of claim 15, wherein the applying of the thermochromic composition involves applying thermochromic composition that is ink or epoxy resin.

21. The method of claim 20, wherein applying the thermochromic composition in the form of a ring element means applying said thermochromic composition in the form of a ring element at a distance of between approximately one half an inch and approximately two inches from the smooth area of glass or metal.

22. The method of claim 15, wherein applying the thermochromic composition in the form of a ring element means applying said thermochromic composition in the form of a ring element that has at least one interrupted portion thereof, said at least one interrupted portion including a symbol that conveys that the smooth top surface is dangerously hot

23. The method of claim 22, wherein applying the thermochromic composition in the form of a ring element means applying said thermochromic composition in the form of a ring element at a distance of between approximately one half an inch and approximately two inches from the smooth area of glass or metal.

24. The method of claim 22, wherein the applying of the thermochromic composition is performed by spraying, stamping, printing, stenciling, embossing or silk screening the thermochromic composition onto the portion of the top surface.

25. The method of claim 24, wherein the applying of the thermochromic composition involves applying thermochromic composition that is ink or epoxy resin.

26. The method of claim 22, wherein the applying of the thermochromic composition involves applying thermochromic composition that is ink or epoxy resin.

27. The method of claim 26, wherein applying the thermochromic composition in the form of a ring element means applying said thermochromic composition in the form of a ring element at a distance of between approximately one half an inch and approximately two inches from the smooth area of glass or metal.

28. The method of claim 15, wherein in addition to the step of applying the thermochromic composition there is a further step of applying an adjoining element of thermochromic composition adjoining more than one of the ring elements.

29. A method of warning individuals that a top surface of a stove is hot, the stove of a type having a plurality of heating elements each heating element surrounded by a smooth area of the top surface, such as glass or metal, the method comprising:
for each heating element
(a) applying to a surrounding smooth area, which surrounding smooth area represents a portion of the top surface of the stove surrounding the heating element, a heat warning symbol that communicates that part of the heating element or the surrounding smooth area is dangerously hot, said heat warning symbol being able to withstand the temperature of least 300 degrees Fahrenheit,
(b) applying to the surrounding smooth area a thermochromic composition in liquid or semi-liquid state in a form of a ring element, the thermochromic composition designed to undergo and maintain a readily perceptible color change whenever and so long as a part of either the heating element or the surrounding smooth area exceeds a predetermined temperature, the color change of the thermochromic composition revealing the heat warning symbol, and allowing the thermochromic composition to dry to a solid state.

30. The method of claim 29, wherein applying the thermochromic composition means applying a thermochromic composition that is sufficiently similar in color to a background color of the surrounding smooth area that the thermochromic composition and the heat warning symbol are readily visible against the background color of the surrounding smooth area only when and so long as the temperature of the surface exceeds the predetermined temperature.

31. The method of claim 29, wherein the applying of the heat warning symbol is performed by spraying, painting, embossing, stenciling, stamping, printing or silk screening an epoxy or ink in the form of the heat warning symbol.

32. The method of claim 30, wherein applying a heat warning symbol in step (a) means applying a heat warning symbol that has a reflective quality in order to increase visibility.

33. The method of claim 29, wherein the applying of the thermochromic composition is performed by spraying, stamping, printing, stenciling, embossing or silk screening the thermochromic composition onto the portion of the top surface.

34. The method of claim 29, wherein the applying of the heat warning symbol is performed by spraying, painting, embossing, stenciling, stamping, printing or silk screening an epoxy or ink in the form of the heat warning symbol and wherein the applying of the thermochromic composition is performed by spraying, stamping, printing, stenciling, embossing or silk screening the thermochromic composition onto the portion of the smooth top surface.

35. The method of claim 33, wherein the applying of the thermochromic composition involves applying thermochromic composition that is ink or epoxy resin.

36. The method of claim 29, wherein the applying of the thermochromic composition involves applying thermochromic composition that is ink or epoxy resin.

37. The method of claim 29, wherein applying the thermochromic composition in the form of a ring element means applying said thermochromic composition in the form of a ring element that has at least one interrupted portion thereof, said at least one interrupted portion including a symbol that conveys that the top surface is dangerously hot

38. The method of claim 37, wherein the applying of the heat warning symbol is performed by spraying, painting, embossing, stenciling, stamping, printing or silk screening an epoxy or ink in the form of the heat warning symbol.

39. The method of claim 37, wherein the applying of the thermochromic composition is performed by spraying, stamping, printing, stenciling, embossing or silk screening the thermochromic composition onto the portion of the smooth top surface.

40. The method of claim 37, wherein the applying of the heat warning symbol is performed by spraying, painting, embossing, stenciling, stamping, printing or silk screening an epoxy or ink in the form of the heat warning symbol and wherein the applying of the thermochromic composition is performed by spraying, stamping, printing, stenciling, embossing or silk screening the thermochromic composition onto the portion of the smooth top surface.

41. The method of claim 39, wherein the applying of the thermochromic composition involves applying thermochromic composition that is ink or epoxy resin.

42. The method of claim 37, wherein the applying of the thermochromic composition involves applying thermochromic composition that is ink or epoxy resin.

43. The method of claim 29, wherein the applying of the heat warning symbol is performed by spraying, painting, embossing, stenciling, stamping, printing or silk screening an epoxy or ink in the form of the heat warning symbol, said heat warning symbol being able to withstand temperatures of at least 400 degrees Fahrenheit.

44. The method of claim 43, wherein the applying of the heat warning symbol is performed by spraying, painting, embossing, stenciling, stamping, printing or silk screening an epoxy or ink in the form of the heat warning symbol, said heat warning symbol being able to withstand temperatures of at least 500 degrees Fahrenheit.

45. The method of claim 29, wherein in addition to the step of applying the thermochromic composition there is a further step of applying an adjoining element of thermochromic composition adjoining more than one of the ring elements.

46. The method of claim 29, wherein applying a heat warning symbol in step (a) means applying a heat warning symbol that has a reflective quality in order to increase visibility.
